(19) United States
(12) Patent Application Publication
(10) Pub. No.: US 2012/0091786 A1
(43) Pub. Date: Apr. 19, 2012

(54) Vehicle Hydraulic Brake System with Wheel Slip Control

(75) Inventors: Philipp Frueh, Clayton (AU); Rainer Brueggemann, Ludwigsburg (DE); Andreas Reize, Adelsheim (DE)

(73) Assignee: Robert Bosch GmbH, Stuttgart (DE)

(21) Appl. No.: 13/273,324

(22) Filed: Oct. 14, 2011

(30) Foreign Application Priority Data
Oct. 15, 2010 (DE) 10 2010 042 534.6

(51) Int. Cl. B60T 13/138

(52) U.S. Cl. 303/10

(57) ABSTRACT

A vehicle hydraulic brake system with wheel slip control includes two brake circuits and brake pressurization valves and brake pressure-reduction valves for each wheel brake. The two brake circuits are connected by a connecting valve in the form of a non-return valve on a side of the wheel brakes remote from the brake pressure valves. The connecting valve permits a more rapid build-up of the wheel brake pressure in the wheel brakes of the one brake circuit when a brake pressure in the other brake circuit is lower.

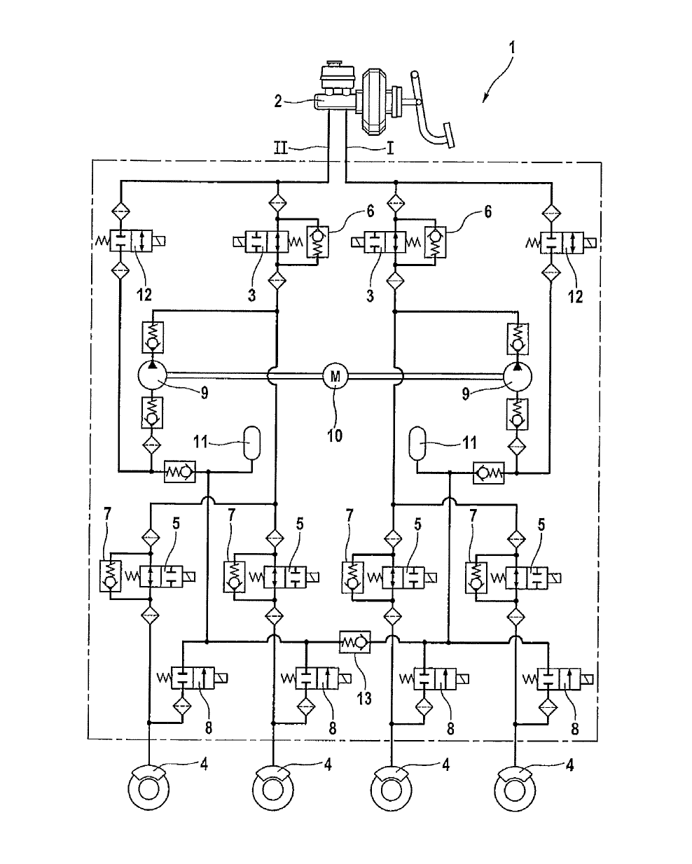

This application claims priority under 35 U.S.C. §119 to German patent application no. DE 10 2010 042 534.6, filed on Oct. 15, 2010 in Germany, the disclosure of which is incorporated herein by reference in its entirety.

### BACKGROUND

The disclosure relates to a vehicle hydraulic brake system with wheel slip control.

Such a vehicle brake system is disclosed by the published patent application DE 41 32 470 A1. The known vehicle brake system comprises a dual-circuit brake master cylinder, to which two brake circuits are connected, to each of which in turn two hydraulic wheel brakes are connected. Each brake circuit comprises a brake pressurization valve and a brake pressure-reduction valve for each connected wheel brake. The brake pressurization valve serves to connect the respective wheel brake to the brake master cylinder, whilst the brake pressure-reduction valve connects it to the suction side of a hydraulic pump, a hydraulic pump being provided in each brake circuit and the hydraulic pumps being driven by a common electric motor. On the suction side of the hydraulic pumps, a hydraulic accumulator, to which the wheel brakes are consequently connected by the brake pressure-reduction valves, is arranged in each brake circuit. The hydraulic pumps are often also referred to, although not altogether accurately, as return pumps.

The brake pressurization valves and the brake pressure-reduction valves form wheel brake pressure modulation valve arrangements, which allow wheel brake pressures in the wheel brakes and thereby wheel braking forces to be regulated independently on each individual wheel. The hydraulic accumulators serve for the buffer storage of brake fluid, which, for reducing the braking force of a wheel brake, flows out of the respective wheel brake due to opening of the respective brake pressure-reduction valve. The hydraulic pumps serve for building up a brake pressure and/or for pumping brake fluid from the wheel brakes back to the brake master cylinder. The independent wheel brake pressure modulation on each individual wheel as described affords scope for a wheel slip control system, for example anti-lock braking, traction control and/or dynamic stability control, commonly referred to by the abbreviations ABS, ASR, ESC and/or DSC.

### SUMMARY

The vehicle brake system according to the disclosure comprises a connecting valve, which connects the two brake circuits of the vehicle brake system to one another, or by means of which the two brake circuits can be connected through opening of the connecting valve, the opening of the connecting valve, for example, possibly occurring automatically in the case of a non-return valve, for example, or being controlled in the case of a solenoid valve, for example. The list of control possibilities and types of valve cited for the connecting valve is not exhaustive. The connecting valve is arranged between the sides of the brake pressure-reduction valves remote from the wheel brakes, that is to say between the suction sides of the hydraulic pumps or between the hydraulic accumulators, where hydraulic pumps or hydraulic accumulators are provided. At least one wheel brake is connected to each brake circuit.

The connecting valve according to the disclosure allows a more rapid reduction of a wheel brake pressure in a brake circuit in that brake fluid from the wheel brakes connected to this brake circuit flows out not only into this brake circuit but also into the other brake circuit. The flow of brake fluid out of the wheel brakes of a brake circuit into this brake circuit and into another brake circuit is possible only if the wheel brake pressure in the wheel brakes of the one brake circuit is greater than the pressure in the other brake circuit. The facility for connecting the two brake circuits through the connecting valve according to the disclosure is regarded as advantageous, despite the fact that the accelerated buildup of pressure in the wheel brakes of the one brake circuit of the vehicle brake system according to the disclosure is possible only in some states of the vehicle brake system and impossible in other states of the vehicle brake system. The more rapid buildup of wheel brake pressure in the wheel brakes of one brake circuit allows a more rapid reduction of the braking force of these wheel brakes and hence shorter wheel slip times of the associated vehicle wheels. It is thereby possible to stabilize a vehicle more rapidly and thereby more efficiently in the case of anti-lock braking or dynamic stability control. This facility is advantageous even when it varies as a function of a pressure differential between the two brake circuits and is therefore not always possible.

The vehicle brake system according to the disclosure comprises a brake pressure generator, to which the brake circuits are connected. The brake pressure generator may be a brake master cylinder that can be actuated by muscular energy, that is to say by foot or by hand. The brake master cylinder may comprise a brake booster, for example a vacuum or an electromechanical brake booster. Vacuum brake boosters are often also referred to as vacuum brake power assist units. The vehicle brake system may also be a so-called vehicle power brake system, which comprises a hydraulic pump as brake pressure generator. The list of brake pressure generators cited is not exhaustive.

The vehicle brake system according to the disclosure may comprise more than two brake circuits. In this case at least two of the brake circuits are or can be connected to one another by a connecting valve. It is also possible to provide more than one connecting valve, which valves connect more than two brake circuits to one another.

Advantageous embodiments and developments of the disclosure are set forth below.

### BRIEF DESCRIPTION OF THE DRAWING

The disclosure is explained in more detail below with reference to an exemplary embodiment represented in the drawing. The single FIGURE shows a hydraulic circuit diagram of a vehicle brake system with wheel slip control according to the disclosure.

### DETAILED DESCRIPTION

The vehicle hydraulic brake system 1 according to the disclosure represented in the drawing comprises a muscular energy-actuated dual-circuit brake master cylinder 2, to which two brake circuits I, II are connected. Each brake circuit I, II is connected to the brake master cylinder 2 by an isolating valve 3.

Each brake circuit I, II comprises two wheel brakes 4, which are connected to the respective brake circuit I, II via brake pressurization valves 5. The number of two wheel brakes 4 in each brake circuit I, II is not mandatory for the disclosure. Non-return valves 6, 7 are hydraulically connected in parallel to the isolating valves 3 and the brake pressurization valves 5, the non-return valves 6 of the isolating valves 3 being capable of carrying a flow from the brake master cylinder 2 to the wheel brakes 4 and the non-return valves 7 of the brake pressure-reduction valves 5 being capable of carrying a flow from the wheel brakes 4 to the brake master cylinder 2.

A brake pressure-reduction valve 8, which serves for connecting the wheel brake 4 to a suction side of a hydraulic pump 9, is assigned to each wheel brake 4. Each brake circuit I, II comprises a hydraulic pump 9, which pumps can be driven by a common electric motor 10. Hydraulic accumulators 11 are connected on the suction sides of the hydraulic pumps 9. In addition, the suction sides of the hydraulic pumps 9 can be connected to the brake master cylinder 2 by intake valves 12.

The valves 3, 5, 8, 12 of the vehicle brake system 1 are 2/2-way solenoid valves. The isolating valves 3 and the brake pressurization valves 5 are open in their de-energized basic position; the brake pressure-reduction valves 8 and the intake valves 12 are closed in their de-energized basic position, although this is likewise not mandatory according to the disclosure.

The brake pressurization valves 5 and the brake pressure-reduction valves 8 form wheel brake pressure modulation valve arrangements, which allow wheel brake pressures in the wheel brakes 4 to be regulated independently on each individual wheel. In the case of wheel slip control, brake pressure is built up by the hydraulic pumps 9, in which process the brake master cylinder 2 may but need not necessarily be actuated. In the event of wheel slip control, the isolating valves 3 are normally closed and the brake circuits I, II are thereby hydraulically isolated from the brake master cylinder 2. Opening of the intake valves 12 allows the hydraulic pumps 9 to draw brake fluid out of the brake master cylinder 2. Wheel slip control through independent wheel brake pressure modulation on each individual wheel, using the brake pressurization valves 5 and the brake pressure-reduction valves 8, is known in the art and will not be explained in more detail here. Anti-lock braking, traction control and/or dynamic stability control, commonly referred to by the abbreviations ABS, ASR, DSC and/or ESC, are possible for example.

On the sides of the brake pressure-reduction valves 8 remote from the wheel brakes 4, the vehicle brake system 1 according to the disclosure comprises a connecting valve 13, which connects the two brake circuits I, II. The suction sides of the hydraulic pumps 9, and the hydraulic accumulators 11 of the two brake circuits I, II, are or can be connected to one another by the connecting valve 13. In the exemplary embodiment of the disclosure shown, the connecting valve 13 is a non-return valve, which is capable of carrying a flow from one brake circuit I to the other brake circuit II. Provided that the wheel brake pressure in the wheel brakes 4 of the one brake circuit I is greater than the brake pressure on the suction side of the hydraulic pump 9 and in the hydraulic accumulator 11 of the other brake circuit II, on opening of a brake pressure-reduction valve 8 of the one brake circuit I, brake fluid flows through the brake pressure-reduction valve 8 into the hydraulic accumulator 11 of the one brake circuit I and through the connecting valve 13 into the hydraulic accumulator 11 of the other brake circuit II. A wheel brake pressure in the wheel brake 4 is thereby reduced more rapidly and a braking force of the wheel brake 4 diminishes more rapidly. A wheel slip time of the corresponding vehicle wheel is shortened, with the result that the vehicle wheel recovers or increases a lateral control force more rapidly. It is thereby possible to stabilize the vehicle more rapidly and more efficiently in the case of anti-lock braking or dynamic stability control.

In the exemplary embodiment of the disclosure represented and described, wheel brakes 4 of front wheels of the vehicle are connected to the one brake circuit I, from which brake fluid can flow through the connecting valve 13 into the other brake circuit II. The reason for this is that the braking force and the wheel brake pressure are usually higher in the wheel brakes of the front axle than in the wheel brakes of the rear axle. A reduction of the wheel brake pressure in wheel brakes of the front axle in order to get locking wheels to rotate again therefore usually takes longer than in wheel brakes of the rear axle. The disclosure allows the reduction of the wheel brake pressure in wheel brakes of the front axle to be speeded up. It is not mandatory, however, for the wheel brakes 4 of the front wheels of the vehicle to be connected to the one brake circuit I.

The connecting valve 13 may be a spring less non-return valve or (as shown) a spring-loaded non-return valve. In the case of a spring-loaded non-return valve, the wheel brake pressure in the wheel brakes 4 of the one brake circuit I must exceed the pressure on the suction side of the hydraulic pump 9 and in the hydraulic accumulator 11 of the other brake circuit II by a differential pressure, occasioned by the non-return valve that forms the connecting valve 13, in order that brake fluid can flow through an opened brake pressure-reduction valve 8 out of a wheel brake 4 of the one brake circuit I into the hydraulic accumulator 11 of the other brake circuit II. The spring-loaded non-return valve forming the connecting valve 13 may therefore also be thought of as a differential pressure valve. It is also possible to use a controllable valve, for example a 2/2-way solenoid valve, as connecting valve 13 (not shown).

What is claimed is:

1. A vehicle hydraulic brake system with wheel slip control, comprising:
a brake pressure generator;
at least two brake circuits which are connected to the brake pressure generator;
at least one hydraulic wheel brake in each brake circuit which is connected to the brake circuit, the brake circuits comprising at least one brake pressurization valve and one brake pressure-reduction valve for the wheel brakes via which the wheel brakes are connected to the brake circuits; and
a connecting valve which serves to connect the two brake circuits to one another on their sides of the brake pressure-reduction valves remote from the wheel brakes.

2. The vehicle hydraulic brake system with wheel slip control according to claim 1, wherein the connecting valve is a non-return valve which connects the two brake circuits of the vehicle brake system and is configured to carry a flow in the direction of one of the two brake circuits.

3. The vehicle hydraulic brake system with wheel slip control according to claim 1, wherein the connecting valve is a differential pressure valve which connects the two brake circuits when a pressure on a side of the brake pressure-reduction valves of the one brake circuit remote from the wheel brakes exceeds the pressure on a side of the brake pressure-reduction valves of the other brake circuit remote from the wheel brakes by a differential pressure.

4. The vehicle hydraulic brake system with wheel slip control according to claim 1, wherein the connecting valve is configured to carry a flow from one brake circuit into the other brake circuit, that wheel brakes of rear wheels of a vehicle are connected to the other brake circuit, into which the connecting valve is configured to carry a flow, and that wheel brakes of front wheels of the vehicle are connected to the one brake circuit, from which the connecting valve is configured to carry a flow in the direction of the other brake circuit.

5. The vehicle hydraulic brake system with wheel slip control according to claim 1, wherein the vehicle brake system comprises a hydraulic pump in at least one brake circuit to the suction side of which pump the wheel brakes of this brake circuit are connected by the brake pressure-reduction valves.

6. The vehicle hydraulic brake system with wheel slip control according to claim 1, wherein the vehicle brake system comprises a hydraulic accumulator in at least one brake circuit to which accumulator the wheel brakes of this brake circuit are connected by the brake pressure-reduction valves.

7. The vehicle hydraulic brake system with wheel slip control according to claim 1, wherein the brake pressure generator is a brake master cylinder.
